(19) United States
(12) Patent Application Publication
(10) Pub. No.: US 2021/0279384 A1
(43) Pub. Date: Sep. 9, 2021

(54) SIMULTANEOUS TOPOLOGY AND FIBER ALIGNMENT OPTIMIZATION FOR ANISOTROPIC MATERIALS

(71) Applicant: Arris Composites Inc., Berkeley, CA (US)

(72) Inventors: Luis Gonzalo BAHAMONDE JACOME, El Cerrito, CA (US); Yang SHEN, El Cerrito, CA (US)

(21) Appl. No.: 16/811,537

(22) Filed: Mar. 6, 2020

(51) Int. Cl. G06F 30/23; G06T 17/20

(52) U.S. Cl. CPC G06F 30/23; G06F 2119/06; G06T 17/20

(57) ABSTRACT

A system and methods are disclosed for designing components made from fiber-reinforced anisotropic materials. In accordance with one embodiment, each of a plurality of finite elements of a physical design space are associated with a respective index value that quantifies inclusion of the finite element in a fiber-reinforced component. Each of the finite elements along a longitudinal axis of a fiber of the component are associated with a respective vector specifying a direction of the fiber within the finite element. One or more inputs are provided to a Finite Element Analysis (FEA) simulation for execution by the FEA simulation, where the input(s) are based on the index values and the vectors. A computer system determines a shape for the component and an orientation of the fiber based on one or more outputs of the FEA simulation.

### STATEMENT OF RELATED APPLICATIONS

The present application is related to U.S. patent application Ser. No. 16/666,191 (Attorney Docket No. 3181-009US1, entitled “Method for the Design and Efficient Manufacture of Fiber-Composite Parts”), filed Oct. 28, 2019, which is incorporated by reference herein.

### FIELD OF THE INVENTION

The present disclosure relates to anisotropic materials.

### BACKGROUND

Anisotropic materials are materials having physical properties that change with direction. Components made from anisotropic materials, such as fiber-reinforced polymers (FRPs), can have better strength-to-weight and stiffness-to-weight ratios than components made from isotropic materials, such as steel and aluminum.

### SUMMARY

Embodiments of the present disclosure are directed to the design of components made from fiber-reinforced anisotropic materials. For convenience, such components are referred to in this disclosure as “FRP components,” recognizing that they might be made from a fiber-reinforced anisotropic material that is not a polymer.

When designing FRP components, optimizing the orientation of fibers in view of anticipated loading conditions can maximize the component's efficiency and performance. For example, an FRP component in which fibers are oriented along the principal direction of stress will have a higher strength and stiffness than FRP components in which fibers are oriented uniformly (e.g., continuous fiber sheet laminates, etc.) or randomly (e.g., chopped fiber injection-molded components, chopped fiber compression molded component, etc.).

The disclosed embodiments provide several benefits lacking in alternative design methods:
First, embodiments of the present disclosure enable both the shape of an FRP component and its constituent fiber paths to be designed simultaneously.
Second, embodiments of the present disclosure are capable of utilizing existing “off the shelf” finite element analysis (FEA) simulations as-is, without modification. This eliminates the need to obtain access to the FEA simulation's source code, as well as the effort and know-how that would be required to modify the source code appropriately. Notably, methods of the present disclosure are formulated to utilize design parameters that can be accepted by most existing FEA simulations (e.g., stiffness properties of any anisotropic material, etc.) and simulation outputs that can be extracted from such simulations (e.g., stress, strain, strain energy, displacements, etc.), which greatly facilitates interfacing with most FEA simulations.
Third, embodiments of the present disclosure operate in a holistic manner, integrating the various functions and aspects of the design process, rather than compartmentalizing them into separate, sequential tasks, as is done in the prior art (for example, first optimizing component topology, then building a computer-aided design [CAD] based on the topology optimization, then performing a finite element analysis [FEA], then plotting a stress trajectory, etc.).
Fourth, embodiments of the present disclosure can be readily incorporated into existing component design techniques.

With respect to the second bullet point of paragraph [0008] above, embodiments of the present disclosure enable a first party (e.g., a first person, a first organization, etc.) to design a fiber-reinforced component using an FEA simulation provided by a second party. More particularly, embodiments of the present disclosure enable a method for designing a fiber-reinforced component using a computer system associated with a first party, where the method comprises: determining respective values of a physical property for each of a plurality of finite elements of a physical design space; identifying an executable of an FEA simulation, where the executable is provided by a second party and is generated from source code unavailable to the first party; providing the respective physical property values to the FEA simulation for execution by the FEA simulation; and determining, by the computer system, a shape for the component and an orientation of a fiber of the component based on one or more outputs of the FEA simulation.

### BRIEF DESCRIPTION OF THE DRAWINGS

FIGS. 1a and 1b depict a flow diagram of aspects of a method for designing the shape and fiber orientation of a fiber-reinforced component simultaneously, in accordance with one implementation of the present disclosure.

FIG. 2 depicts a block diagram of an illustrative computer system operating in accordance with aspects and implementations of the present disclosure.

### DETAILED DESCRIPTION

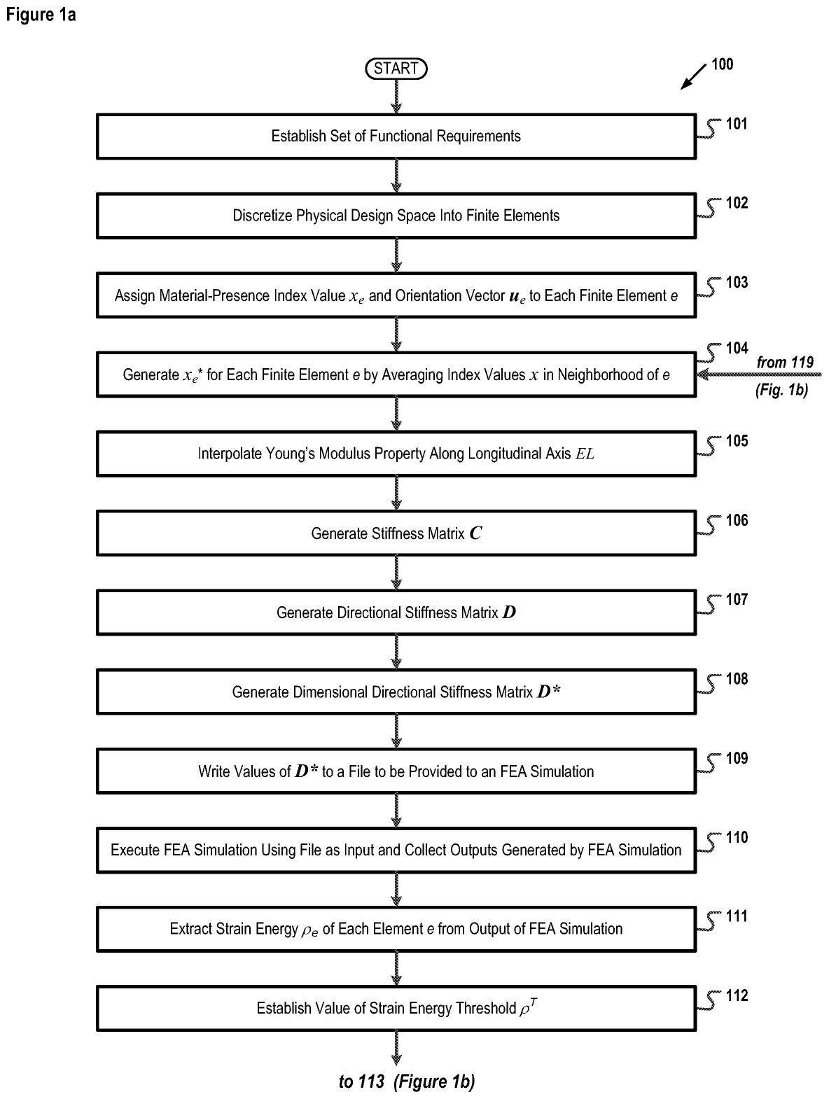

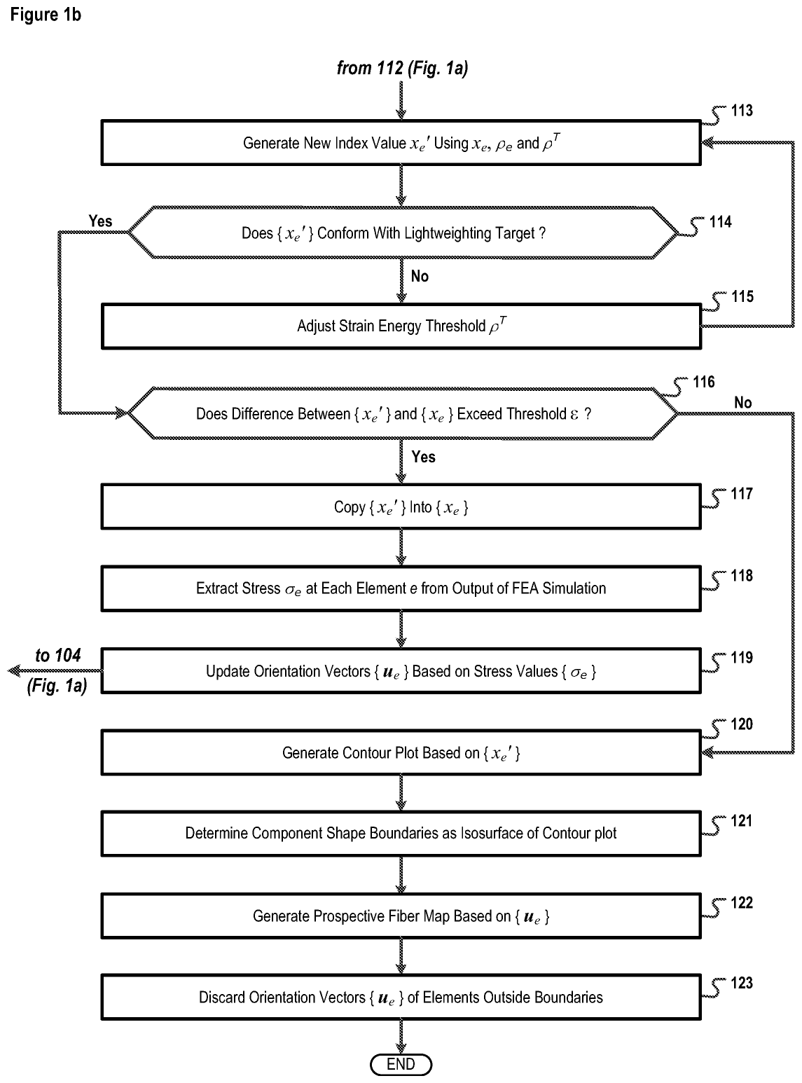

FIGS. 1a and 1b depict a flow diagram of aspects of a method 100 for simultaneously optimizing topology and fiber orientation of an FRP component, in accordance with one embodiment of the present disclosure. The method is performed by processing logic that might comprise hardware (circuitry, dedicated logic, etc.), software (such as is run on a general-purpose computer system or a dedicated machine), or a combination of both. In some embodiments, blocks depicted in FIG. 1 might be performed concurrently, or in a different order than that depicted.

At block 101, a set of functional requirements of an FRP component is established. In some embodiments, the functional requirements might include one or more of the following: the physical design space available to the component; relevant material properties (e.g., engineering constants such as longitudinal and transversal Young modulus [E_{L} and E_{T}], longitudinal-transversal shear modulus [G_{LT}], longitudinal-transversal Poisson ratio [ν_{LT}], Poisson ratio between two perpendicular transverse directions [ν_{TT}], etc.); anticipated loading conditions; a lightweighting target that quantifies the desired reduction in the weight of the initial design of the component; and a minimum feature size for manufacture of the component.

In one embodiment, a “feature” is any structural member of the component, such as a bar of a truss, or a variable-thickness wall. The size of a feature can be defined based on the type of feature; for example, the feature size of a bar might be defined as its cross section, while the feature size of a variable-thickness wall might be defined as the minimum thickness of the wall, and so forth. In some implementations, the minimum feature size is defined as the radius of a sphere. The use of the minimum feature size and sphere radius is described in detail below with respect to block 104.

At block 102, the physical design space available for the component is discretized into finite elements. At block 103, each finite element e is assigned a material-presence index value, denoted xₑ, and an orientation vector uₑ that specifies the direction of the fibers present in the finite element. In one embodiment, the material-presence index is an indication of how beneficial the finite element is to the component topology. For example, if xₑ is 1 (or in practice, is close to one, such as a number above a selected threshold [for example, 0.999]), then the element is designated as solid and is kept in the component's design. If xₑ is 0 (or in practice, is close to zero, such as a number below a selected threshold [for example, 0.001]), then the element is designated as void and is removed from the component, thereby changing the shape of the component. In some embodiments, rather than using two thresholds, one close to 0 and one close to 1, a single threshold of 0.5 might be employed, effectively binarizing the finite elements. In such embodiments, finite elements having a material-presence index value below 0.5 are excluded from the component design, while elements having an index value greater than or equal to 0.5 are included in the component. In some implementations, the values of the material-presence indices might be initialized based on the specified lightweighting target. For example, a lightweighting target of 0.7 (i.e., 30% lighter) would translate into an initial material-presence index value of 0.7 for each of the finite elements. It should be noted that in some implementations, the initial material-presence index values might vary among finite elements, rather than being uniform. Further, in some implementations the orientation vectors for the finite elements might be initialized to a uniform value, while in some other implementations, the results of a preliminary FEA simulation run might be used to initialize the vectors.

At block 104, the material-presence index value of each finite element e, xₑ, is averaged with respect to the material-presence index values of other finite elements within a neighborhood of finite element e. This averaging, or filtering, of the material-presence index values over repeated iterations of the loop in FIG. 1 (i.e., blocks 103 through 119) causes each neighborhood of finite elements to become either all solid or all void. By setting the size of the neighborhood equal to the specified minimum feature size, each of the resultant features of the design will be at least as large as this minimum size. When the minimum feature size is expressed as the radius of a sphere, the filtering ensures that each of the resultant features is at least as large as this sphere.

At block 105, the filtered material-presence index value for each finite element e, denoted xₑ*, is used to interpolate the Young's modulus property along the direction of the fiber's longitudinal axis E_{L}. In embodiments in which fibers are bundled within the component and impregnated with resin, the interpolation range might extend from a very small value (e.g., 10-9) to the nominal longitudinal Young's modulus of the fiber bundle.

At block 106, a stiffness matrix C is generated. The stiffness matrix is a non-dimensional stiffness matrix of a transversely isotropic material constructed with non-dimensional engineering constants. The stiffness matrix C can be generated from its inverse C⁻¹, which is defined as:

$${[ C ]}^{- 1} = [ \begin{matrix}1 & - {v}_{LT} & - {v}_{LT} & 0 & 0 & 0 \\ - {v}_{LT} & \frac{{E}_{L}}{{E}_{T}} & - {v}_{TT} \frac{{E}_{L}}{{E}_{T}} & 0 & 0 & 0 \\ - {v}_{LT} & - {v}_{TT} \frac{{E}_{L}}{{E}_{T}} & \frac{{E}_{L}}{{E}_{T}} & 0 & 0 & 0 \\ 0 & 0 & 0 & 2 ( 1 + {v}_{TT} ) \frac{{E}_{L}}{{E}_{T}} & 0 & 0 \\ 0 & 0 & 0 & 0 & \frac{{E}_{L}}{{G}_{LT}} & 0 \\ 0 & 0 & 0 & 0 & 0 & \frac{{E}_{L}}{{G}_{LT}}\end{matrix} ]$$

At block 107, a directional stiffness matrix, denoted D, is generated from (i) stiffness matrix C, (ii) orientation vectors {uₑ}, and (iii) engineering constants in the set of functional requirements corresponding to material properties other than the longitudinal Young's modulus (e.g., transverse Young modulus, longitudinal-transverse shear modulus, longitudinal-transverse Poisson ratio, the Poisson ratio between two perpendicular transverse directions, etc.). The directional stiffness matrix D is, like stiffness matrix C, non-dimensional.

The individual values of matrix D represent the directional stiffness of each finite element, per the materials-defined modulus. In one embodiment, matrix D is generated by rotating the stiffness matrix C in accordance with the orientation vectors {uₑ}.

At block 108, the non-dimensional directional stiffness matrix D is multiplied by the interpolated E_{L} values (i.e., the interpolated longitudinal Young's modulus), which are scalar, to generate a dimensional directional stiffness matrix, denoted D*. In this multiplication, each element of matrix D, which represents the directional stiffness of the element, is multiplied by the interpolated-E_{L} value for that element.

At block 109, values of the dimensional directional stiffness matrix D* are written to a file to be provided to an FEA simulation. The matrix values are arranged in the file and formatted in accordance with the particular FEA simulation's input file format. In some implementations, the input file may contain other types of data (e.g., data related to acoustics, data related to thermal performance, etc.) in addition to data related to stiffness.

At block 110, The FEA simulation is executed using the values in the file as input, and the outputs generated by the simulation (e.g., in the form of an output file, etc.) are collected.

After the FEA simulation has completed its execution, data is extracted from the output of the FEA simulation (block 111). As indicated above, the particular data extracted are present in the output of most existing FEA simulations.

In one embodiment, the strain energy of each finite element e, denoted ρₑ, is extracted from the simulation output. The strain energy ρₑ quantifies, in a single number, the total amount of work necessary to deform finite element e, and therefore reflects how critical finite element e is to the load path of the component.

In one embodiment, a strain energy threshold is used in conjunction with the finite elements' strain energies {ρₑ} to guide the design of the component. The value of this threshold, denoted ρ^{T}, is established at block 112.

In one such embodiment, the value of threshold ρ^{T} might be determined at block 112 based on the values of the finite elements' strain energies {ρₑ}. Because strain energy is an output of most FEA simulations, there is no need to run the FEA simulation repeatedly or intrude upon its source code in order to establish the value of threshold ρ^{T}.

In one example, the value of threshold ρ^{T} is based on a volume average of the strain energies {ρₑ}, where the volume of an element is the product of the element's size multiplied by its material-presence index. Threshold ρ^{T} is thus a physical counterpart to a Lagrange multiplier.

In another example, the value of threshold ρ^{T} may be determined based on the derivative of the finite elements' strain energies with respect to their material-presence indices (i.e., in aggregate, rather than individual derivatives for each finite element), as in the embodiment of paragraph [0036] below.

At block 113, the strain energy ρₑ and unfiltered material-presence index xₑ for each finite element e is used in conjunction with the strain energy threshold ρ^{T} to generate a prospective new material-presence index for element e. In one embodiment, the new material-presence index, denoted xₑ′, is based on the method of Lagrange multipliers and is computed using the following equation:

$${x}_{e}^{′} = {{x}_{e} ( k \frac{{ρ}_{e}}{{ρ}^{T}} )}^{η}$$

where k and η are numerical stabilization constants.

As a result, the strain energy of an element and its relation to the strain energy threshold govern how the element's material-presence index is updated. More particularly, when the strain energy of an element exceeds the threshold, its material-presence index is increased, and the element is more likely to be retained. Conversely, when the strain energy of an element is below the threshold, its material-presence index is reduced, and the element is more likely to be removed from the component, thereby reducing mass. In the case where the strain energy threshold is set to the average of the finite elements' strain energies {ρₑ}, elements that have a below-average strain energy are effectively penalized for “not doing their fair share of the work,” while elements that have an above-average strain energy are “rewarded” with an increased material-presence index.

At block 114, a prospective component shape corresponding to the prospective new indices {xₑ′} is evaluated for conformance with the lightweighting target. In one implementation, the shape is determined by computing a weighted sum Σₑ[xₑ′·size(e)] over all finite elements e, and this weighted sum is compared to the lightweighting target to determine conformance. For example, if the lightweighting target is a 30% reduction in weight, then block 114 checks whether the weighted sum is less than or equal to 0.7*T, where T is the total size of the finite elements. If the prospective component shape meets the lightweighting target, then execution continues at block 116; otherwise, execution proceeds to block 115.

In another implementation, the shape is determined by binarizing each of the {xₑ′} to zero or one using a threshold of 0.5, as described above in paragraph [0013]. In accordance with this implementation, conformance with the lightweighting target is determined in the same way as paragraph [0030] above (i.e., by computing weighted sum Σₑ[xₑ′·size(e)] and comparing it to the target). In this case, however, the weighted sum represents the total size of the elements that are retained in the shape (i.e., the elements whose xₑ′ equals 1).

At block 115, the strain energy threshold ρ^{T} is adjusted with the objective of moving the weight of the prospective component shape closer to the lightweighting target. When the threshold ρ^{T} is adjusted higher, the number of elements whose strain energy exceeds the threshold will either decline or stay the same in the next iteration of loop 113-115. This results in fewer elements, or possibly the same number of elements, receiving upward adjustments to their material-presence index in the next iteration, and, similarly, a larger number of elements, or possibly the same number of elements, receiving downward adjustments in the next iteration. As a result, the weight of the prospective component will either decline or stay the same.

Moreover, even when the upward adjustment of threshold ρ^{T} does not change the number of elements that are above and below the threshold, the weight of the prospective component will still decline or stay the same because of the decrease in the ratios {(ρₑ/ρ^{T})}. More particularly, when the {xₑ′} are left as-is (i.e., as fractional values within [0, 1], rather than binarizing them to {0, 1} as in the implementation of paragraph [0031] above), then decreasing the ratios {(ρₑ/ρ^{T})} will decrease the values of the {xₑ′}, which in turn decreases the weighted sum of these values, thereby lowering the weight of the prospective component. Alternatively, in the case where the prospective component shape is determined by binarizing the {xₑ′}, then decreasing the ratios {(ρₑ/ρ^{T})} will decrease (or possibly leave unchanged) the number of elements whose updated index xₑ′ is greater than or equal to the binarizing index threshold 0.5. This in turn decreases (or leaves unchanged) the number of elements that are retained in the prospective component shape, and consequently decreases (or leaves unchanged) the weight of the prospective component.

Downward adjustments to threshold ρ^{T} have the opposite effect: they increase, or possibly leave unchanged, the weight of the prospective component. While increasing the weight of the component might seem undesirable, the rationale for doing so might be an assumption that a component that is too light (i.e., below the target weight) might not have sufficient strength, where “sufficient strength” might refer to the strength necessary to withstand anticipated load conditions, or the strength necessary to withstand the same amount of load that the initial design is capable of withstanding, or some other criterion.

After block 115 has completed, execution continues back at block 113, using the updated strain energy threshold ρ^{T}.

In one embodiment, blocks 112, 113, 114 and 115, can be implemented by a root-finding algorithm. In one example, the root-finding algorithm is applied to the function ƒ(xₑ′)=xₑ′·[xₑ′·size(e)]−target, where target is the lightweighting target. In one such example, a general root-finding algorithm is constructed by a logic loop such that a new xₑ′ will be calculated from

$${x}_{e}^{′} = {{x}_{e} ( k \frac{{ρ}_{e}}{{ρ}^{T}} )}^{η}$$

until ƒ(xₑ′) gets close to zero.

In one implementation, a bracketing-based root-finding algorithm is used to solve for the strain energy threshold ρ^{T}, where the initial endpoints of the bracket are two extreme strain energy values, one where the lightweighting target is overshot (i.e., the design is heavier than the target, corresponding to ƒ(xₑ′)>target), and one where the lightweighting target is undershot (i.e., the design is lighter than the target, corresponding to ƒ(xₑ′)<target). Alternatively, some other type of root-finding algorithm might be used to solve for ρ^{T} (e.g., a gradient-based algorithm such as the Newton-Raphson method, where the arithmetic mean of the strain energies {ρₑ} might be used as the initial estimate).

Block 116 is reached once the prospective component shape, as characterized by new indices {xₑ′}, has met the lightweighting target. The new indices {xₑ′} are compared at block 116 to the previous unfiltered material-presence indices {xₑ}. In one embodiment, the difference between {xₑ′} and {xₑ} is computed as Σₑ(xₑ′−xₑ)² (i.e., the square of the Euclidean distance), and the value of this summation is compared to a threshold ε. In some implementations the value of threshold ε might be specified in the set of functional requirements, while in some other implementations this value might be hard-coded.

If Σₑ(xₑ′−xₑ)² is greater than threshold ε, then execution proceeds to block 117; otherwise, execution continues at block 120, which is described below.

In accordance with another embodiment, rather than consolidating the pairwise differences into a single overall value (e.g., the square of the Euclidean distance, etc.) and comparing this value to a threshold, the pairwise differences are individually compared to a pairwise threshold. Using this approach, execution continues at block 120 only when every pairwise difference is less than the pairwise threshold.

At block 117, the values of the new indices {xₑ′} are copied into variables {xₑ}.

At block 118, the stress at each finite element e, denoted σₑ, is extracted from the output of the FEA simulation. As indicated above, stress is a standard output of FEA simulations.

At block 119, orientation vectors {uₑ} are updated based on the extracted stress values {σₑ}. In one embodiment, the orientation vectors are updated by minimizing a failure index having a maximum-stress failure criterion. In one implementation, the stress re for each element e is used for:
computing the eigenvalues and associated eigenvectors of the matrix of the stress tensor for that element;
identifying the eigenvalue with the highest absolute value; and
updating the orientation vector uₑ with eigenvector associated with this eigenvalue.
   In some other embodiments, the orientation vectors {uₑ} might be updated in some other manner (e.g., by minimizing a failure index that has a failure criterion other than maximum stress, such as the Tsai-Wu index, the Tsai-Hill index, etc.).

After block 119 has completed, execution proceeds back to block 104. Blocks 104 through 116 are then executed again, using the updated material-presence indices {xₑ} and updated orientation vectors {uₑ}. In this way, incremental refinements are made at each iteration of the loop, pushing the component toward an optimum design.

At block 120, a contour plot within the physical design space is generated based on the final material-presence index values {xₑ′}. In one embodiment, the optimized filtered material-presence index values {xₑ*} are plotted as isosurfaces (i.e., surfaces of isovalues) in the three-dimensional physical design space. In one example, the filtered index values {xₑ*} are associated with the centroids of the finite elements in order to plot the isosurfaces, similar to the fiber map's associating of the orientation vectors {uₑ} with the elements' centroids. The filtered index values {xₑ*} at the nodes (i.e., the vertices of the finite elements) are approximated by the filtered index values at the centroids, and a continuous interpolation function is constructed for generating the isosurfaces.

Block 120 is reached when the difference between the new material-presence index values {xₑ′} and the prior values {xₑ} falls below threshold ε. This implies that further iterations are unlikely to yield meaningful improvements, which in turn implies that the geometry of the component has converged upon a shape that is “close enough” to optimum.

Because the amount of energy stored within a component depends upon the component's shape, the stored energy, and therefore the fiber paths, are also expected to converge. As a result, the shape of the component and the fiber paths are optimized simultaneously, where an optimal design is one in which all of the elements have the same strain energy E. In such a design, where the strain energies {ρₑ} are the same, the work (or equivalently, energy) put into the component is distributed into as small as possible values throughout the component. In implementations where a threshold ρ^{T} is employed, the value of E equals ρ^{T}, and convergence is the process in which the strain energies {ρₑ} move toward ρ^{T}.

It should be noted that the optimized fiber paths are not necessarily “ideal” with respect to all possible criteria. For example, some embodiments may use strength rather than strain energy as a criterion for aligning the fibers. In such embodiments, ideal fiber paths will be realized when the strengths of the elements are minimized. While ideal fiber paths may not be achievable, by getting sufficiently close to the ideal, optimized results can be obtained as compared to the initial design or as compared to sequential approaches.

Similarly, as the strain energies {ρₑ} converge toward ρ^{T}, the shape of the component approaches the ideal in which all elements store the same amount of strain energy, thereby distributing the work/energy throughout the structure in the smallest possible values. Accordingly, the fiber paths that are realized are optimized for the converged shape, even when the ideal shape is not reached.

At block 121, boundaries corresponding to the shape of the component are determined. In one implementation, the boundaries are an isosurface of the contour plot. In one such implementation, an isovalue is selected by a user based on engineering judgment and/or using an isosurface visualization tool, and the shape boundary is defined as the isosurface corresponding to the selected isovalue.

At block 122, a prospective fiber map is generated based on the updated vectors. The fiber map associates the orientation vector uₑ for each element e with the centroid of the element, and is used to generate a three-dimensional vector/quiver plot.

At block 123, the fiber orientation vectors uₑ of finite elements outside the boundaries are discarded. After block 123 has completed, the method of FIG. 1 terminates.

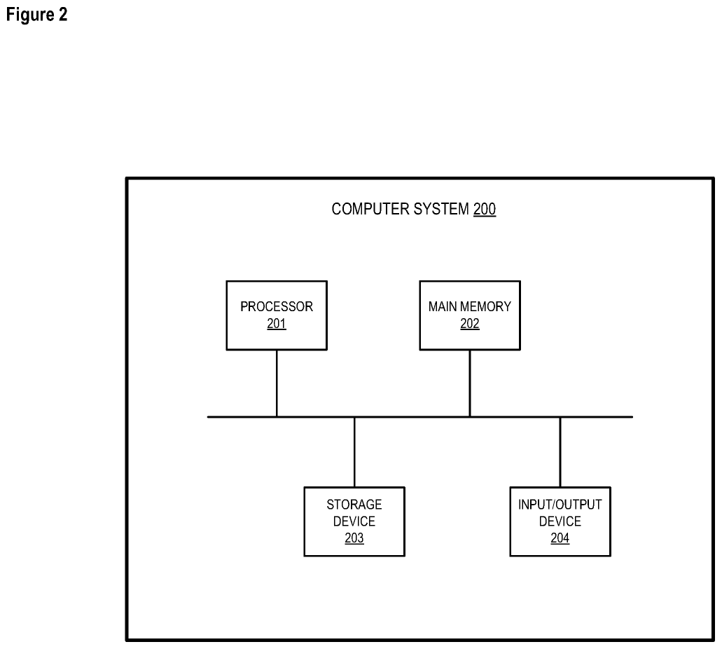

FIG. 2 depicts a block diagram of an illustrative computer system 200 operating in accordance with aspects and implementations of the present disclosure. Computer system 200 may be a personal computer (PC), a laptop computer, a tablet computer, a smartphone, or any other computing or communication device. As shown in FIG. 2, computer system 200 comprises processor 201, main memory 202, storage device 203, and input/output (I/O) device 204, interconnected as shown (e.g., via one or more busses, etc.).

Processor 201 represents one or more general-purpose processing devices such as a microprocessor, central processing unit, or the like. More particularly, processor 201 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor 201 may also be one or more special-purpose processing devices such as an application specific integrated circuit (ASIC), a field programmable gate array (FPGA), a digital signal processor (DSP), network processor, or the like. Processor 201 is capable of executing instructions stored in main memory 202 and storage device 203, including instructions corresponding to the method of FIG. 1 above; of reading data from and writing data into main memory 202 and storage device 203; and of receiving input signals and transmitting output signals to input/output device 204. While a single processor is depicted in FIG. 2 for simplicity, computer system 200 might comprise a plurality of processors.

Main memory 202 is capable of storing executable instructions and data, including instructions and data corresponding to the method of FIG. 1 above, and may include volatile memory devices (e.g., random access memory [RAM]), non-volatile memory devices (e.g., flash memory), and/or other types of memory devices.

Storage device 203 is capable of persistent storage of executable instructions and data, including instructions and data corresponding to the method of FIG. 1 above, and may include a magnetic hard disk, a Universal Serial Bus [USB] solid state drive, a Redundant Array of Independent Disks [RAID] system, a network attached storage [NAS] array, etc. While a single storage device is depicted in FIG. 2 for simplicity, computer system 200 might comprise a plurality of storage devices.

I/O device 204 receives input signals from a user of computer system 200, forwards corresponding signals to processor 201, receives signals from processor 201, and emits corresponding output signals that can be sensed by the user. The input mechanism of I/O device 204 might be an alphanumeric input device (e.g., a keyboard, etc.), a touchscreen, a cursor control device (e.g., a mouse, a trackball, etc.), a microphone, etc., and the output mechanism of I/O device 204 might be a liquid-crystal display (LCD), a cathode ray tube (CRT), a speaker, etc. While a single I/O device is depicted in FIG. 2 for simplicity, computer system 200 might comprise a plurality of I/O devices.

As indicated above, a further benefit of embodiments of the present disclosure is that they can be readily incorporated into existing component design techniques. One such example is the process disclosed in U.S. patent application Ser. No. 16/666,191 (Attorney Docket No. 3181-009US1, entitled “Method for the Design and Efficient Manufacture of Fiber-Composite Parts”, incorporated by reference), which is directed toward the design of fiber-composite parts. In this example, aspects of the method of FIG. 1 of the present disclosure can function as a particular implementation of block S301 of the process (FIG. 3), or as an implementation of one or both of blocks S505 and S506 (FIG. 5).

What is claimed:

1. A method comprising:
associating each of a plurality of finite elements of a physical design space with a respective index value that quantifies inclusion of the finite element in a fiber-reinforced component;
associating, for each of the finite elements along a longitudinal axis of a fiber of the component, a respective vector specifying a direction of the fiber within the finite element;
computing, based on the index values, respective values of a Young's modulus property for finite elements along the longitudinal axis of the fiber;
providing a set of one or more inputs to a Finite Element Analysis (FEA) simulation for execution by the FEA simulation, the set of one or more inputs based on the Young's modulus property values;
updating, by a computer system, the index values based on a first set of one or more outputs of the FEA simulation;
updating, by the computer system, the vectors based on a second set of one or more outputs of the FEA simulation; and
determining, by the computer system, a shape for the component and an orientation of the fiber based on the updated index values and the updated vectors.

2. The method of claim 1 wherein the set of one or more inputs comprises respective directional stiffness values for the plurality of finite elements, and wherein the directional stiffness values are based on the Young's modulus property values.

3. The method of claim 1 wherein the first set of one or more outputs of the FEA simulation comprises respective strain energy values for the plurality of finite elements.

4. The method of claim 3 wherein the updating of the index values is further based on a strain energy threshold, and wherein the strain energy threshold is based on one or more of the strain energy values.

5. The method of claim 4 wherein the updating of the index values comprises:
generating a first set of updated index values based on the strain energy threshold;
adjusting the strain energy threshold based on the first set of updated index values; and
generating a second set of updated index values based on the adjusted strain energy threshold.

6. The method of claim 1 wherein the second set of one or more outputs of the FEA simulation comprises respective stress values for the plurality of finite elements.

7. The method of claim 6 wherein the vectors are updated by minimizing a failure index that has a failure criterion other than maximum stress.

8. A method for refining a design of a fiber-reinforced component, wherein the design specifies a first shape of the component and a first orientation of a fiber of the component, the method comprising:
providing a first set of one or more inputs to a Finite Element Analysis (FEA) simulation for a first execution of the FEA simulation, wherein the first set of one or more inputs is based on the first shape and the first orientation;
determining, by a computer system, a second shape of the component and a second orientation of the fiber based on a set of one or more outputs from the first execution of the FEA simulation;
providing a second set of one or more inputs to the FEA simulation for a second execution of the FEA simulation, wherein the second set of one or more inputs is based on the second shape and the second orientation; and
determining, by a computer system, a third shape of the component and a third orientation of the fiber based on a set of one or more outputs from the second execution of the FEA simulation.

9. The method of claim 8 wherein the first set of one or more inputs is based on respective index values for a plurality of finite elements of a physical design space, and wherein the index value for a finite element quantifies inclusion of the finite element in the component.

10. The method of claim 9, wherein the method further comprises computing, based on the index values, respective values of a Young's modulus property for finite elements along the longitudinal axis of the fiber, and wherein the first set of one or more inputs is based on the Young's modulus property values.

11. The method of claim 10, wherein the method further comprises computing, based on the Young's modulus property values, respective directional stiffness values for the plurality of finite elements, and wherein the first set of one or more inputs is based on the directional stiffness values.

12. The method of claim 9 wherein the set of one or more outputs from the first execution of the FEA simulation comprises respective strain energy values for the plurality of finite elements.

13. The method of claim 12 further comprising:
updating the index values based on one or more of the strain energy values; and
generating the second set of one or more inputs based on the updated index values.

14. The method of claim 8 wherein the determining of the third shape is based on a contour plot that is generated based on the one or more outputs from the second execution of the FEA simulation.

15. The method of claim 8, wherein the one or more outputs from the second execution of the FEA simulation comprises respective stress values for the plurality of finite elements;
and wherein the method further comprises:
updating, based on the stress values, a vector specifying a direction of the fiber within a finite element; and
generating a fiber map based on the updated vector;
and wherein the determining of the third orientation of the fiber is based on the fiber map.

16. A method comprising:
associating each of a plurality of finite elements of a physical design space with a respective index value that quantifies inclusion of the finite element in a fiber-reinforced component;
associating, for each of the finite elements along a longitudinal axis of a fiber of the component, a respective vector specifying a direction of the fiber within the finite element;
providing one or more inputs to a Finite Element Analysis (FEA) simulation for execution by the FEA simulation, the one or more inputs based on the index values and the vectors; and
determining, by a computer system, a shape for the component and an orientation of the fiber based on one or more outputs of the FEA simulation.

17. The method of claim 16 wherein the one or more inputs comprises respective directional stiffness values that are based on the respective index values.

18. The method of claim 17 wherein the one or more inputs further comprises data related to at least one of acoustics or thermal performance.

19. The method of claim 16 wherein the one or more outputs of the FEA simulation comprises respective strain energy values and respective stress values for the plurality of finite elements.

20. The method of claim 16 wherein the determining of the shape is based on a contour plot generated from the one or more outputs of the FEA simulation, and wherein the determining of the orientation of the fiber is based on a fiber map generated from the one or more outputs of the FEA simulation.

21. A method comprising:
determining respective directional stiffness values for each of a plurality of finite elements of a physical design space;
providing the respective directional stiffness values to a Finite Element Analysis (FEA) simulation for execution by the FEA simulation;
identifying, from one or more outputs of the executed FEA simulation, respective strain energy values for each of the finite elements; and
determining, by a computer system, a shape for a fiber-reinforced component and an orientation of a fiber of the component based on the respective strain energy values.

22. The method of claim 21, wherein the method further comprises identifying, from the one or more outputs of the executed FEA simulation, respective stress values for each of the finite elements, and wherein the determining of the orientation of the fiber is further based on the respective stress values.
